(19) United States
(12) Patent Application Publication
(10) Pub. No.: US 2013/0175014 A1
(43) Pub. Date: Jul. 11, 2013

(54) METHOD OF JOINING TUBE AND TUBE SHEET IN SHELL &TUBE HEAT EXCHANGER AND SHELL & TUBE HEAT EXCHANGER PRODUCED BY THE METHOD

(71) Applicants: Seonghui HONG, Busan (KR); Changsu Kim, Busan (KR); Chanhyo Bae, Busan (KR)

(72) Inventors: Seonghui HONG, Busan (KR); Changsu Kim, Busan (KR); Chanhyo Bae, Busan (KR)

(73) Assignee: DongHwa entec Co., Ltd., Gangseo-gu (KR)

(21) Appl. No.: 13/369,386

(22) Filed: Feb. 9, 2012

(30) Foreign Application Priority Data
Jan. 9, 2012 (KR) 10-2012-0002419

(51) Int. Cl. F28D 7/00; B23K 31/02

(52) U.S. Cl. 165/157; 228/165

(57) ABSTRACT

A method of joining tubes that are regularly arranged in a shell & tube heat exchanger to tube sheets placed at opposite ends of the tubes and a shell & tube heat exchanger produced by the method. The method of joining the tubes to the tube sheets includes: forming a tube sheet groove in a surface of the tube sheet at a location spaced apart from a tube insert hole of the tube sheet by a predetermined distance, and forming a tube holding groove in an inner surface of the tube insert hole; inserting the tube into the tube insert hole of the tube sheet and expanding the tube; and performing both tube side welding and shell side welding so as to join the tube to the tube sheet, wherein the shell side welding is performed by inserting a welding torch into the tube.

### REFERENCE TO RELATED APPLICATIONS

This application claims the priority benefit of Korean Patent Application No. 10-2012-002419 filed on Jan. 9, 2012, the entire contents of which are incorporated herein by reference.

### FIELD OF THE INVENTION

The present invention relates, in general, to a shell & tube heat exchanger and, more particularly, to a method of joining tubes that are regularly arranged in a shell and tube heat exchanger to tube sheets placed at opposite ends of the tubes, and to a shell & tube heat exchanger produced by the method.

### BACKGROUND OF THE INVENTION

Generally, a shell & tube heat exchanger is a representative heat exchanger which is fabricated using tube sheets and a set of heat transfer tubes (hereinbelow, referred to simply as tubes) joined to the tube sheets, with a cylindrical shell hermetically surrounding the tubes and the tube sheets. The shell & tube heat exchanger is used to perform a variety of heat transfer functions, such as heating, cooling, condensing and evaporating.

FIG. 1 is a view illustrating the construction of a conventional shell & tube heat exchanger.

Referring to FIG. 1, different fluids flow through the shell & tube heat exchanger; one fluid flows through tubes (the tube side) and another fluid flows outside the tubes but inside a shell (the shell side) and heat is transferred between the different fluids. Generally, the fluid flowing into the shell side uses a fluid having a normal temperature, such as water or sea water, and the fluid flowing into the tube side uses another fluid, such as gas, but it should be understood that examples of the fluids flowing into the tube side and into the shell side are not limited to the above-mentioned fluids. Baffle plates 30 are provided in the shell so as to form a zigzag flowing passage of the fluid that flows outside the tubes but inside the shell. Opposite ends of each tube are welded to respective tube sheets 20 so as to prevent the fluid inside the tubes from mixing with the fluid outside the tubes but inside the shell.

Hereinbelow, a method of joining the tubes to the tube sheets in the conventional shell & tube heat exchanger shown in FIG. 1 will be described.

Each of the tube sheets 20 is provided with tube insert holes. Each of the tubes 10 is inserted into an associated tube insert hole of the tube sheet 20 and is expanded through a tube expansion using a ball or water pressure, so that the tube 10 is closely fixed to the tube sheet 20. Thereafter, tube side welding 14 is performed at junctions between the tube 10 and the tube sheet 20 so as to firmly join the tube 10 to the tube sheet 20. Here, tube side welding refers to welding that is performed to prevent the fluid flowing into and from the tube from infiltrating into a gap between the tube and the tube sheet. The tube side welding is performed by welding an outside portion of the junction between the tube and the tube sheet (in other words, a portion that is in contact with the fluid flowing into and from the tube).

However, the conventional shell & tube heat exchanger that is produced both by the tube expansion and by the tube side welding is problematic in that the tube expansion may not be able to put the tube and the tube sheet into completely close contact with each other, but may form a micro crevice (a crevice that has a micro size and is not viewable with the naked eye) in the junction between the tube and the tube sheet, thereby forming a hole in the tube by crevice corrosion. Particularly, when the fluid flowing into the shell uses sea water, the quantity of ions in the crevice is reduced and breaks the electrical equilibrium, so that CI ions infiltrate into the crevice so as to maintain electrical neutrality, thereby allowing acidification to progress in a part and corrode the tube.

Accordingly, a method is required of more firmly joining the tube and the tube sheet in the shell & tube heat exchanger.

### SUMMARY OF THE INVENTION

Accordingly, the present invention has been made keeping in mind the above problems occurring in the related art, and the present invention is intended to propose a method of joining a tube and a tube sheet in a shell & tube heat exchanger and to propose a shell & tube heat exchanger produced by the joining method, in which the tube and the tube sheet are completely joined to each other, thereby preventing a fluid flowing into and from the shell from forming holes in the tube due to incomplete joining of the tube to the tube sheet in the shell & tube heat exchanger, and preventing tube corrosion.

The objects of the present invention are not limited to the above-mentioned object, but other objects of the present invention will be more clearly understood from the following description.

In order to achieve the above objects, according to one aspect of the present invention, there is provided a method of joining a tube and a tube sheet in a shell & tube heat exchanger, including: forming a tube sheet groove in a surface of the tube sheet at a location spaced apart from a tube insert hole of the tube sheet by a predetermined distance, and forming a tube holding groove in an inner surface of the tube insert hole; inserting the tube into the tube insert hole of the tube sheet and expanding the tube; and performing both tube side welding and shell side welding so as to join the tube to the tube sheet, wherein the shell side welding is performed by inserting a welding torch into the tube.

Here, a thickness of a welding portion formed in the tube sheet by the tube sheet groove may be equal to a thickness of the tube.

Further, each of the tube sheet groove and the tube holding groove has a ring shape.

In another aspect, the present invention provides a shell & tube heat exchanger formed by joining a tube to a tube sheet, wherein a tube sheet groove is formed in a surface of the tube sheet at a location spaced apart from a tube insert hole of the tube sheet by a predetermined distance, and a tube holding groove is formed in an inner surface of the tube insert hole, and the tube is expanded and both tube side welding and shell side welding are performed so as to join the tube to the tube sheet, wherein the shell side welding is performed by inserting a welding torch into the tube.

The present invention is advantageous in that it is possible to prevent the fluid flowing into and from the shell in the shell & tube heat exchanger from forming holes in the tube and to more firmly join the tube to the tube sheet, thereby preventing the fluid flowing into and from the shell from corroding the tube, accordingly, preventing safety accidents which occur in the heat exchanger and extending the expected lifespan of the heat exchanger.

### BRIEF DESCRIPTION OF THE DRAWINGS

The above and other objects, features and further advantages of the present invention will be more clearly understood from the following detailed description when taken in conjunction with the accompanying drawings, in which:

FIG. 1 is a view illustrating the construction of a conventional shell & tube heat exchanger; and

FIG. 2 is a sectional view illustrating a method of joining a tube and a tube sheet in a shell & tube heat exchanger according to a preferred embodiment of the present invention.

### DETAILED DESCRIPTION OF THE INVENTION

Hereinbelow, a method of joining a tube sheet and a tube in a shell & tube heat exchanger according to the present invention will be described in detail with reference to the accompanying drawings.

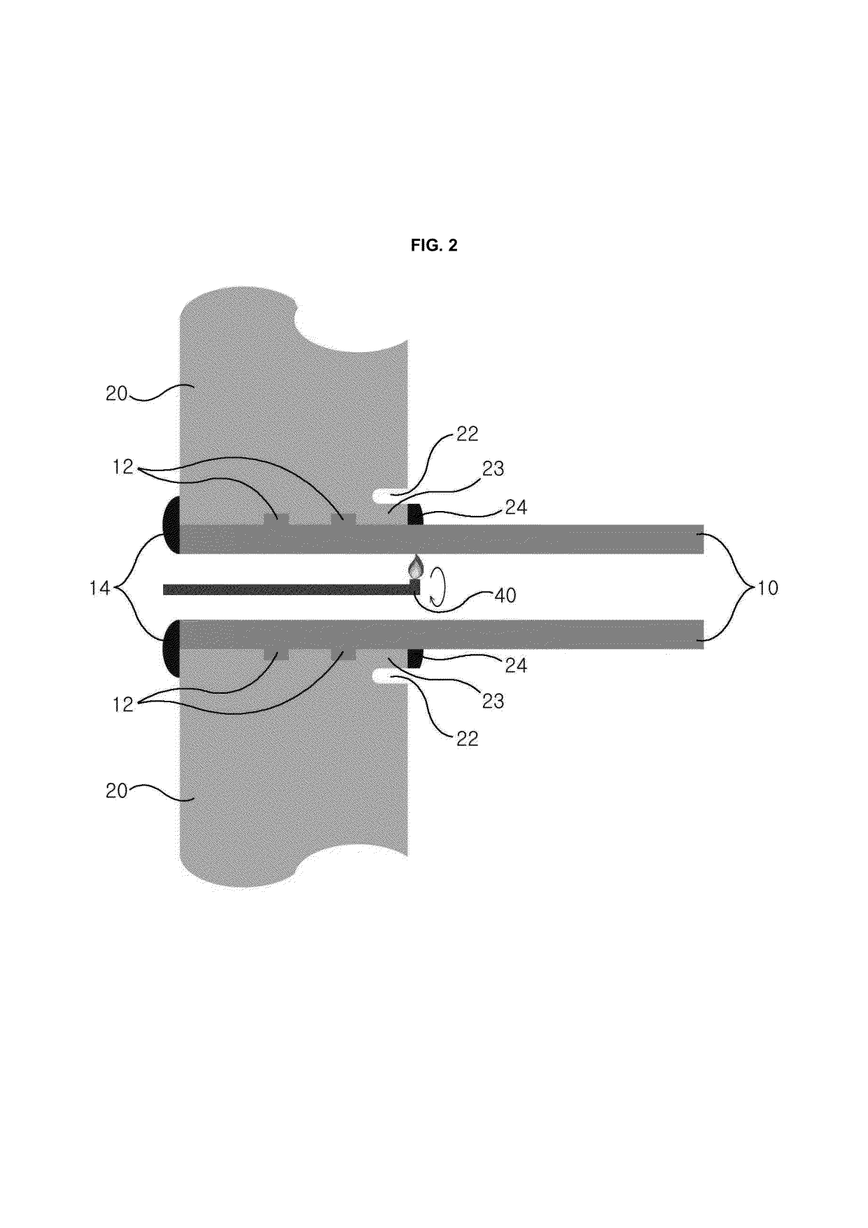

FIG. 2 is a sectional view illustrating a method of joining a tube and a tube sheet in a shell & tube heat exchanger according to a preferred embodiment of the present invention.

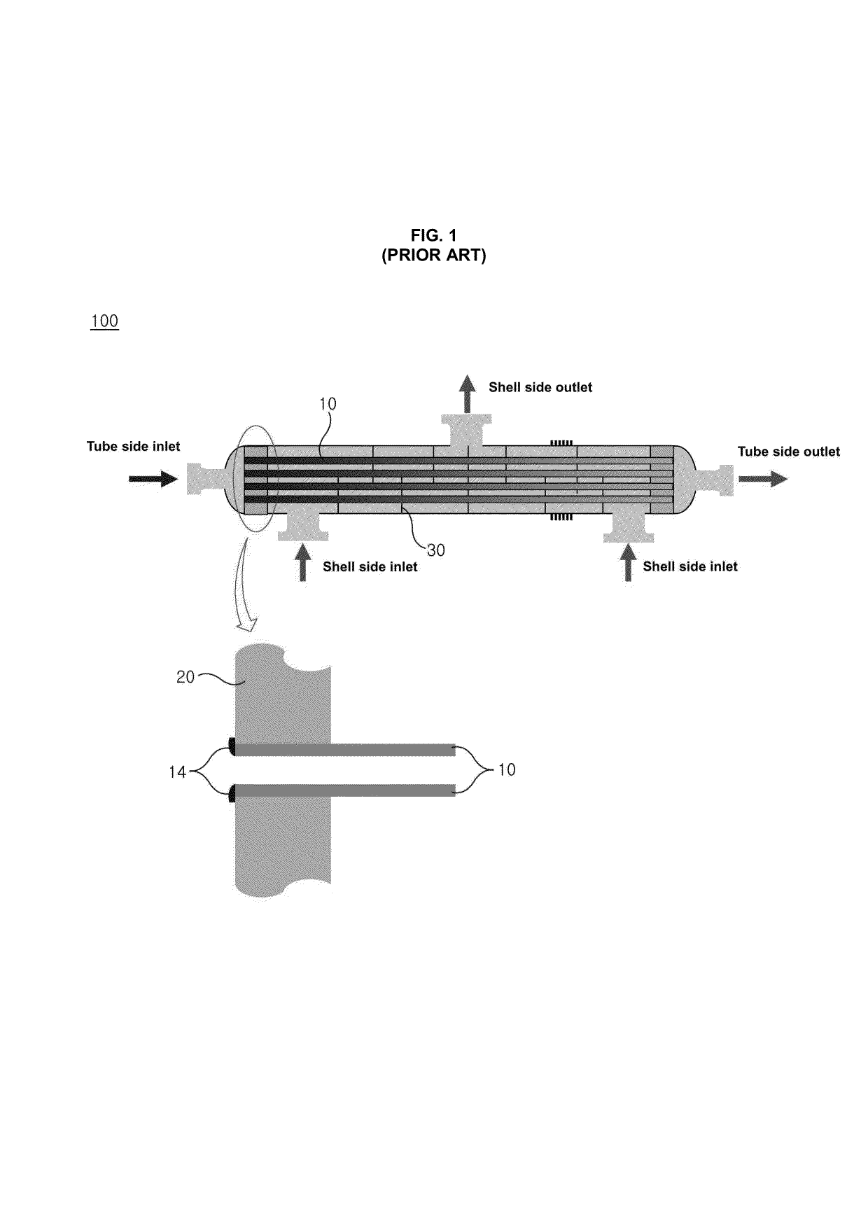

Referring to FIG. 2, the present invention is characterized in that to join the tube 10 to the tube sheet 20 in the shell & tube heat exchanger, shell side welding 24 is performed in addition to both tube expansion and the tube side welding 14 that was described with reference to FIG. 1.

Here, shell side welding 24 is a counterpart of the above-mentioned tube side welding 14 and refers to welding that is performed to prevent the fluid flowing into the shell (see FIG. 1) from infiltrating into a junction between the tube and the tube sheet. As shown in FIG. 2, shell side welding is performed by welding an inside portion of the junction between the tube and the tube sheet (in other words, a portion that is in contact with the fluid flowing into and from the shell).

Shell side welding 24 is performed by forming a tube sheet groove 22 in an inside surface of the tube sheet 20 and by welding the tube 10 to the tube sheet 20 using a welding torch 40 that is inserted into the tube 10. In other words, the welding torch (heating source) 40 that is inserted into the tube 10 heats the material of the tube and welds the tube 10 to a welding portion 23 that is formed in the tube sheet 20 by the tube sheet groove 22.

In the present invention, the reason that the tube sheet groove 22 is formed in the inside surface of the tube sheet 20 is so that shell side welding can be performed easily and efficiently by heating the tube sheet 20 not as a whole, but partially in such a way that the welding can be completed by heating the welding portion 23 that is formed by the tube sheet groove 22 in the tube sheet 20. Here, the thickness of the tube 10 is typically about 1.6 mm and the thickness of the welding portion 23 formed in the tube sheet 20 by the tube sheet groove 22 is preferably set to a level equal to the thickness of the tube 10 so that the welding can be completed by heating the tube sheet partially using a reduced quantity of welding heat and increased welding efficiency.

The tube sheet groove 22 is formed in the inside surface of the tube sheet and in the shape of a ring-shaped groove that surrounds an associated tube insert hole at a location spaced apart from the tube insert hole by a predetermined distance.

The reason that the welding torch is inserted into the tube is so that the tubes that are inserted in the tube sheet can be easily welded. Here, shell side welding is performed in a state in which the tubes are inserted in the tube sheet, so that when one of the tubes is welded, neighboring tubes disturb the welding and remarkably reduce the work efficiency, and it is almost impossible to completely perform the desired welding work. In an effort to overcome the problem, the welding torch is inserted into the tube in the present invention so that shell side welding can be easily performed without the neighboring tubes interfering or being disturbed.

Hereinbelow, the process of joining the tube to the tube sheet in the shell & tube heat exchanger will be described.

First, the tube sheet grooves 22 and tube holding grooves 12 are formed in the tube sheet 20. Here, the tube holding grooves 12 are formed in the tube sheet so as to increase the locking force between the tube and the tube sheet by allowing predetermined parts of the tube to be inserted into the tube holding grooves during a tube expanding process, and the tube sheet grooves 22 are formed to realize easy welding work. As shown in FIG. 2, the tube holding grooves 12 are formed in the inner surface of each tube insert hole of the tube sheet 20 and each tube sheet groove 22 is formed in the inside surface of the tube sheet 20 at a location spaced apart from an associated tube insert hole by a predetermined distance. Here, the tube holding grooves 12 and the tube sheet grooves 22 have ring shapes.

Second, tubes are inserted into respective tube insert holes of the tube sheet and are subjected to a tube expanding process. Accordingly, the tubes are primarily fastened to the tube sheet by the tube expanding process.

Thereafter, a welding process is performed on the inside and outside portions of the junction between each tube and the tube sheet. In other words, the tube side welding 14 and the shell side welding 24 are performed so as to weld the tube 10 to the tube sheet 20. The shell side welding is performed using the welding torch that is inserted into the tube. Here, as described above, the welding torch is inserted into the tube to make the welding work easy.

As described above, in the present invention, shell side welding is performed when joining the tube to the tube sheet of the shell & tube heat exchanger, thereby preventing the infiltration of the fluid that flows into and from the shell, so that holes can be prevented from forming in the tube and the fluid flowing into and from the shell of the heat exchanger can prevent the tube from corroding. In the present invention, to increase the work efficiency of the shell side welding and to increase the locking force between the tube and the tube sheet, shell side welding is performed after forming the tube sheet grooves 22 in the inside surface of the tube sheet 20 and after inserting the welding torch into the tube 10.

As described above, when the tube 10 is joined to the tube sheet 20 of the shell & tube heat exchanger, the present invention performs shell side welding 24 in addition to both the conventional tube expansion and the conventional tube side welding 14, thereby more firmly joining the tube to the tube sheet and, accordingly, preventing holes from forming in the tube and preventing the fluid flowing into and from the shell from causing corrosion of the tube. The present invention can thus prevent safety accidents from occurring in the shell & tube heat exchanger and can extend the expected lifespan of the heat exchanger.

Those skilled in the art will appreciate that a variety of changes and modifications of the present invention is possible without departing from the scope and spirit of the present invention. Accordingly, it should be understood that the above-mentioned preferred embodiment is for illustrative purposes, not limiting the present invention. Further, the scope and spirit of the present invention must be expressed by the accompanying claims rather than the detailed description, and various modifications, additions and substitutions induced from the accompanying claims and the equivalent conception of the claims must be interpreted to be included in the scope and spirit of the present invention.

What is claimed is:

1. A method of joining a tube and a tube sheet in a shell & tube heat exchanger, comprising:
forming a tube sheet groove in a surface of the tube sheet at a location spaced apart from a tube insert hole of the tube sheet by a predetermined distance, and forming a tube holding groove in an inner surface of the tube insert hole;
inserting the tube into the tube insert hole of the tube sheet and expanding the tube; and
performing both tube side welding and shell side welding so as to join the tube to the tube sheet, wherein
the shell side welding is performed by inserting a welding torch into the tube.

2. The method as set forth in claim 1, wherein a thickness of a welding portion formed in the tube sheet by the tube sheet groove is equal to a thickness of the tube.

3. The method as set forth in claim 1, wherein the tube sheet groove has a ring shape.

4. The method as set forth in claim 1, wherein the tube holding groove has a ring shape.

5. A shell & tube heat exchanger formed by joining a tube to a tube sheet, wherein
a tube sheet groove is formed in a surface of the tube sheet at a location spaced apart from a tube insert hole of the tube sheet by a predetermined distance, and a tube holding groove is formed in an inner surface of the tube insert hole, and the tube is expanded and both tube side welding and shell side welding are performed so as to join the tube to the tube sheet, wherein
the shell side welding is performed by inserting a welding torch into the tube.

6. The shell & tube heat exchanger as set forth in claim 5, wherein a thickness of a welding portion formed in the tube sheet by the tube sheet groove is equal to a thickness of the tube.

7. The shell & tube heat exchanger as set forth in claim 5, wherein the tube sheet groove has a ring shape.
